(19) United States
(12) Patent Application Publication
(10) Pub. No.: US 2002/0040319 A1
(43) Pub. Date: Apr. 4, 2002

(54) Method and system for discounting and offering rebates in real estate and rental transactions

(76) Inventor: Jeff Jacob Brauer, New York, NY (US)

Correspondence Address: Ido Tuchman, Suite 503, 69-60 108th Street, Forest Hills, NY, 11375, US

(21) Appl. No.: 09/933,957

(22) Filed: Aug. 20, 2001

Related U.S. Application Data
(60) Provisional application No. 60/226,642, filed on Aug. 21, 2000.

(51) Int. Cl. G06F 17/60

(52) U.S. Cl. 705/14; 705/26

(57) ABSTRACT

A method and system for conducting a real estate transaction between a real estate buyer and a real estate seller using a real estate host. The method includes a receiving step for receiving a property search criteria from the real estate buyer. An assigning step assigns to the real estate buyer a discount code associated with a target property. If the real estate buyer procures the target property, the method further includes paying the real estate buyer a rebate amount and collecting a transaction fee from the real estate seller.

### CROSS-REFERENCE TO RELATED APPLICATIONS

This application claims the benefit of the filing date of U.S. provisional patent application Serial No. 60/226642 entitled METHOD AND APPARATUS FOR DISCOUNTING AND OFFERING REBATES IN REAL ESTATE AND RENTAL TRANSACTIONS, filed Aug. 21, 2000.

### FIELD OF THE INVENTION

The present invention relates to real estate property transactions, and more specifically to conducting real estate transactions between a real estate buyer and a real estate seller using a real estate host.

### BACKGROUND

Real estate brokers typically charge a commission for the rental and sale of real estate properties that optimizes their revenue per transaction. The commission is determined by the supply of available properties on the market and the demand for those properties. The objective is to sell and rent as many properties as possible at a commission that is as high as possible.

Presently, the commissions, while theoretically negotiable, are very inflexible because the client has imperfect knowledge of all available real estate on the market and is just searching for or trying to sell one piece of real estate, whose commission will not appreciably affect a broker's overall revenue, and is therefore not in a position to bargain for a better rate.

Moreover, to date it has been impossible for a third party to aggregate listings and impractical for the multitude of broker firms to do so, since the costs of producing such service must come at least in part from completed deals, and nobody in a completed transaction wants to reduce his or her fee by reporting the transaction.

Each broker knows that since they share access to the same general list of real property available as other brokers and because clients are generally charged the same commission fee by their competitors (with small variations), a broker can serve as many clients as he receives inquiries and loses money on each client who chooses his competitor to offer the same service. However, brokers cannot simply discount their normal fees for all clients without starting a fare war or compromising their underlying fare structure (i.e., without also having to reduce its full-fare prices for walk-in and full-fee customers). Furthermore, brokers are generally required to pay a fee of one-half the going fee rate of 15%, or 7.5%, of the first year's rent to the brokerage firm who discovered and originally listed each particular real estate property for rentals or half the commission for sales.

Offering discounts to particular segments of clients is one way for brokers to draw additional client traffic. However, this practice is generally limited to instances where brokers have longstanding relationships with particular clients and have derived income from previous sales and rentals to them, or where brokers expect an increase in volume (such as by servicing a corporation with multiple real estate needs) in return for the discount.

“Exclusive” rentals and sales are known in the field of real estate brokerage where a particular broker firm has an agreement with a seller or renter to rent or sell their property exclusively through that particular brokerage firm. Exclusive rentals and sales, therefore, permit a particular brokerage firm with the exclusive listing to discount their fee as much as they want, theoretically even below the 7.5% threshold that would otherwise be due to the brokerage firm that discovered and originally listed the real estate property. Exclusive listings, however, represent a small fraction of all available listings, since most clients demand a sale or rental at the going rate and exposure to a market as large as possible. Exclusive listings, therefore, do not solve the problem of how to discount the broker commission fee, preserve a profit calculable in advance for the selling or renting brokerage firm, and thereby offer a discount that makes a particular broker more price competitive than others.

Furthermore, although various “businesses” have existed and continue to exist that collect real estate property for sale and rent and then manually interact with the originating brokerage firm by way of phone, e-mail or fax to inquire about particular real property for sale or rent, these services have not instituted a truly automated discount program through which many real estate broker firms offer properties for sale and rent, and which pays a rebate after a deal is signed.

As such, there is currently no way for real estate broker firms to discount their commission fee, preserve a fixed profit for the selling or renting brokerage firm, and thereby offer a discount that makes such a service more attractive than the service provided by the brokerage firms themselves.

### SUMMARY OF THE INVENTION

The present invention addresses the above-mentioned limitations of traditional real estate transactions by providing a real estate host for discounting and offering rebates in real estate dealings. Thus, an aspect of the present invention involves a method for conducting a real estate transaction between a real estate buyer (or renter) and a real estate seller (or the seller's broker). The method includes a receiving step for receiving a property search criteria from the real estate buyer. An assigning step assigns to the real estate buyer a discount code associated with a target property. If the real estate buyer procures the target property, the method further includes paying the real estate buyer a rebate amount and collecting a transaction fee from the real estate seller.

In accordance with another aspect of the invention, there is provided a system for conducting a real estate transaction. The system includes a real estate seller offering a target property for purchase or rent. A real estate buyer procures the target property from the real estate seller. In addition, a real estate host lists the target property in a host database. The real estate host assigns a discount code to the real estate buyer which is associated to the target property. When the real estate buyer procures the target property, the host pays the real estate buyer a rebate amount.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an overview of one embodiment of the present invention.

FIG. 2 shows a flow chart for an exemplary apartment rental transaction process as contemplated by the present invention.

FIG. 3 shows a flow chart for an exemplary house purchase transaction process as contemplated by the present invention.

FIG. 4 shows an embodiment of the present invention where the buyer finds a target property from some source other than a real estate host.

### DETAILED DESCRIPTION OF THE INVENTION

The present invention is a new and useful technique for conducting real estate transactions between a real estate buyer and a real estate seller. As used herein, the terms “real estate buyer” and “real estate seller” may be various entities including, but not limited to, individuals, businesses, and agents thereof. Additionally, the term “real estate” broadly includes both residential and business property, such as apartments, condominiums, houses, farms, offices, factories, and other buildings or lands. The term “transaction” includes various forms of real estate agreements including, but not limited to, purchase, lease, and rental agreements.

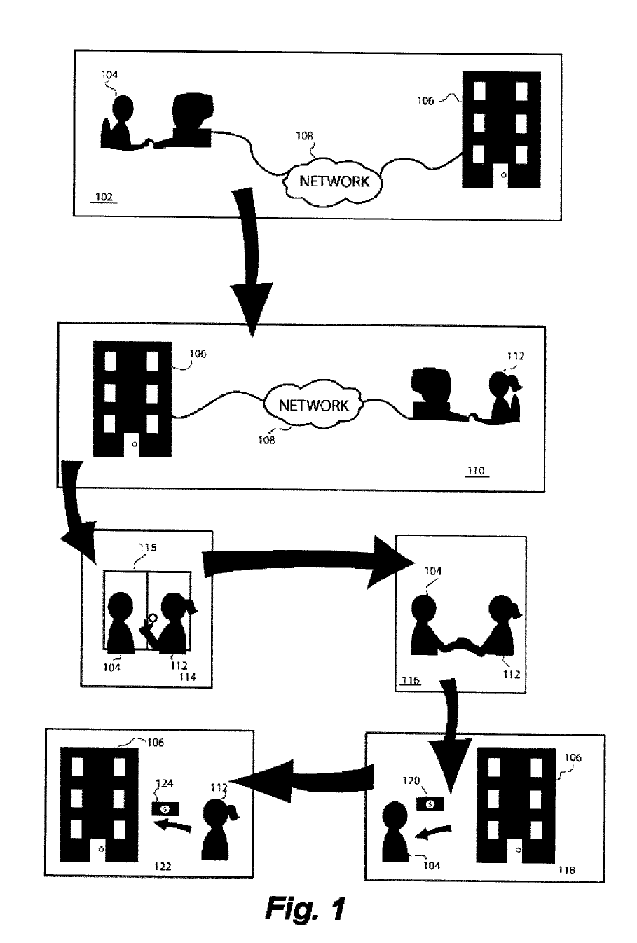

FIG. 1 shows an overview of one embodiment of the present invention. In this embodiment, as shown in panel 102, a real estate buyer 104 searching for property communicates with a real estate host 106. The real estate buyer 104 may be someone seeking to rent or purchase property. It is contemplated that communications between parties using the present invention may be achieved by any conventional communication method known. For example, the real estate buyer 104 and the real estate host 106 may exchange messages using the mail, telephone, fax, or e-mail. In a particular embodiment, communications between the real estate buyer 104 and the real estate host 106 are effectuated over a computer network 108. The computer network 108 may, for example, comprise of a public network such as the Internet or other wide area network (WAN).

During initial communications between the real estate buyer 104 and the real estate host 106, the real estate buyer 104 provides buyer information to the real estate host 106. The buyer information may include a property search criteria and financial qualification information. The property search criteria can specify, for example, a preferred location, a price range, the type of property desired, and whether the property will be purchased or rented. If the buyer has already located a specific property, the property search criteria may simply be the property's location. The financial qualification information may provide, for instance, the buyer's yearly income, the buyer's aggregate debt, credit references, and an authorization to check the buyer's financial background.

Once information from the real estate buyer 104 is received, the real estate host 106 presents the real estate buyer 104 with a list of available properties from a properties database (not shown). The properties presented may be based upon the buyer's search criteria and/or financial qualification. In one embodiment of the invention, the host 106 selectively lists only those properties which the buyer qualifies to purchase or rent, as specified by the property sellers. The buyer 104 then selects a target property from the list that he or she would like to view. The real estate host 106, in turn, assigns the buyer 104 a discount code associated with the target property. As discussed in detail below, the discount code entitles the buyer 104 to redeem a rebate amount from the host 106 after the target property is procured by the buyer 104.

Next, as shown in panel 110, the real estate host 106 communicates with a real estate seller 112 and provides the real estate seller 112 with information about the buyer 104. The real estate seller 112 may be a realtor or a real estate broker representing several property sellers. Communications between the real estate host 106 and the real estate seller 112 may be conducted using conventional communication systems such as the mail, telephone, fax, or e-mail. In a particular embodiment, an Extranet between the host 106 and the real estate seller 112 is created, thus allowing the real estate seller 112 to inspect and modify data relating to property offered by the real estate seller 112 in the properties database. Communications between the real estate host 106 and the real estate broker 112 may be encrypted or otherwise encoded such that secure communications is maintained.

Next, in panel 114, the buyer 104 and seller 112 meet and the target property 115 is shown to the buyer 104. At this stage, the buyer 104 can inspect the property 115 and negotiate a rental or purchase price. It is contemplated that the host 106 may collect a referral fee from the seller 112 after directing the buyer 104 to the seller 112. Once the buyer 104 and the seller 112 come to a mutual agreement over the target property 115, the buyer 104 procures the target property 115 from the seller 112, as shown in panel 116.

In panel 118, the real estate host 106 is shown paying a rebate amount 120 to the buyer 104 after the transaction between the buyer 104 and seller 112 is completed. The buyer 104 redeems the rebate amount 120 by entering the discount code assigned to the buyer and providing proof that the target property 115 was procured by the buyer 104 (such as a signed lease or deed). The rebate amount 120 may be a predetermined fixed amount or a percentage of the transaction price. In addition, the host 106 may first confirm with the seller 112 that the transaction was completed and that the buyer 106 in fact procured the target property.

Next, in panel 122, the real estate host 106 is shown collecting a transaction fee 124 from the seller 112. The transaction fee 124 is typically designed to recover the rebate amount 120 paid to the buyer 104 and may also include an additional real estate hosting fee. The hosting fee may be a fixed payment or may be based on a percentage of the transaction price. It is contemplated that payments by various parties can be made using known payment methods, such as electronic payment, credit card payment, check payment, and the like.

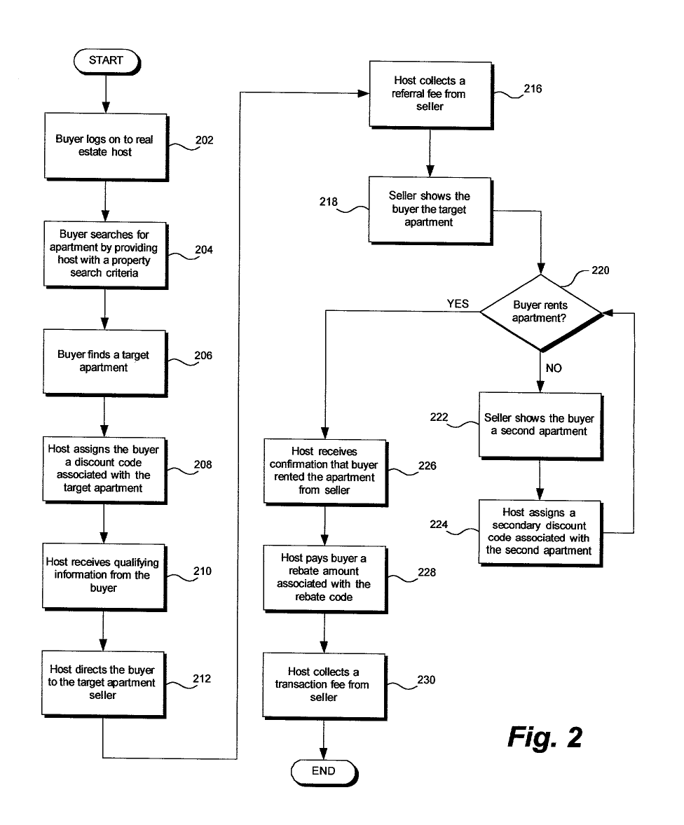

FIG. 2 shows a flow chart for an exemplary apartment rental transaction process as contemplated by the present invention. Although the particular embodiment of FIG. 2 relates to a real estate buyer searching for an apartment to rent or lease, the present invention may also be employed for other types of property as well as other types of property transactions. These other implementations are intended to be included within the scope of the present invention.

The process begins at accessing step 202, wherein the real estate buyer contacts the real estate host. The accessing step 202 can include logging on to the host, creating a client profile, and validating the buyer's identity. After the accessing step 202 is completed, the process flow passes to searching step 204.

Next, in searching step 204, the buyer inputs a property search criteria which specifies the apartment the buyer is interested in renting. In response, the host retrieves apartment descriptions matching the property search criteria. The apartment descriptions are stored in a host database and may contain a brief narrative about each apartment as well as photographs and videos of the apartments. It is contemplated that the apartment descriptions may be viewed by the buyer through a computer network. For example, the buyer may use an Internet connection and a web browser to examine the apartment descriptions. Thus, the present invention beneficially gives the buyer the opportunity to preview the target apartment by examining the apartment description, and gives the seller the opportunity to preview the buyer's credit by examining the buyer's qualifying information.

In one embodiment of the present invention the host database can be updated via a computer network. In such an arrangement, database entries are maintained by subscribing real estate agents who connect to the host using an Extranet or other secure network connection. Once connected, a real estate agent can add, delete, and modify his or her database entries.

After the buyer searches through the apartment descriptions, the buyer selects a target apartment at finding step 206. The target apartment is the apartment which buyer selects to see in person. The buyer may choose more than one target apartment, but for ease of illustration only one target apartment is assumed chosen by the buyer.

Next, at assigning step 208, the host assigns the buyer a discount code associated with the target apartment. The code may be any unique alphanumeric sequence which identifies the target property. In a particular embodiment of the invention, discount codes are created automatically using a key generator algorithm known to those skilled in the art. Once the assigning step 208 is completed, the process flow passes to receiving step 210.

At receiving step 210, the host receives qualifying information from the buyer. As discussed earlier, the qualifying information may include the buyer's yearly income, the buyer's debt, credit references, etc. The qualifying information is used to screen out apartments that the buyer is financially unqualified for and to help the seller determine if the buyer will be a financially stable tenant.

Next, at directing step 212, the host facilitates a person-toperson meeting between the buyer and the seller in order to show the target apartment to the buyer. The host provides the target apartment seller with the buyer's name and contact information so that the seller can schedule an appointment with the seller. Generally, at least some of the qualifying information is also passed from the host to the target apartment seller at directing step 214.

Once host provides the seller with the buyer's name and contact information, the process continues to collecting step 216, wherein the host collects a referral fee from the seller. In embodiments incorporating this step, the seller is billed the referral fee after sufficient information to contact the buyer is provided to the seller by the host. The host may choose to charge some sellers a referral fee and not others.

Next, at showing step 218, the seller shows the target apartment to the buyer. This step provides the buyer with the opportunity to inspect the apartment and determine if it is suitable for the buyer's purposes. Once the buyer views the apartment, control is passed to decision step 220.

If, at decision step 220, the buyer decides not to rent the apartment from the seller, the buyer and seller may choose to look for another apartment that better suits the buyer's needs. This is accomplished at showing step 222, wherein a second apartment is presented to the buyer. During this step, the buyer inspects the second apartment to determine if it is suitable for his or her purposes. After the buyer examines the second apartment, process flow passes to assigning step 224. It should be noted that the buyer may always return to searching step 204 and find a new target apartment if he or she decides not to rent the apartment from the seller.

At assigning step 224, the buyer contacts the host and the host assigns the buyer a second discount code associated with the second apartment. The second discount code enables the buyer to receive a rebate amount on the second apartment if the second apartment is rented by buyer. Process flow then returns to decision step 220, wherein the buyer can decide whether to rent the apartment or not.

Returning to decision step 220, if the buyer does decide to rent the apartment from the seller, process flow passes to confirming step 226. At confirming step 226, the host is contacted and is notified that the buyer has rented the apartment from the seller. Typically the buyer will contact the host and confirm that the apartment was rented, however it is contemplated that the seller may also do so. The confirmation step 226 may include entering data about the negotiated rental agreement, such as the agreed upon rental amount and other terms of the lease. After the confirming step 226 is completed the process flow continues to paying step 228.

At paying step 228, the host prompts the buyer for the rebate code. Once the code is provided and proof of the transaction is received, the host pays the buyer a rebate amount. As discussed earlier, the rebate amount is a predetermined fixed sum of money or a percentage of the deal given to the buyer after the apartment has been rented. In addition, the rebate amount may be given to the buyer in various forms, such as a check or as a credit on the apartment rent. Proof of the transaction may include a copy of the lease signed by the buyer and seller. A copy of the lease may be mailed, faxed, e-mailed, or otherwise conveyed to the host using any known delivery method. It is contemplated that the host may confirm with the seller that the apartment was truly rented to the buyer.

Next, at collecting step 230, the host bills the seller a transaction fee associated with the apartment rented. The transaction fee is also a predetermined sum of money which may be either fixed or a percentage of the agreed upon rental amount. As mentioned previously, the transaction fee generally recovers the rebate amount paid to the buyer and can also include an additional real estate hosting fee. Once the transaction fee is collected from the seller the process is completed.

Those skilled in the art will recognize that many of the operations described above may be implemented automatically using a computer program or algorithm. For example, the real estate host may be programmed to automatically bill the seller for the transaction fee once confirmation that buyer rented the apartment from the seller is received. The logical operations of the algorithm are implemented (1) as a sequence of computer implemented steps running on a computing system and/or (2) as interconnected machine modules within the computing system. The implementation is a matter of choice dependent on the performance requirements of the system implementing the invention.

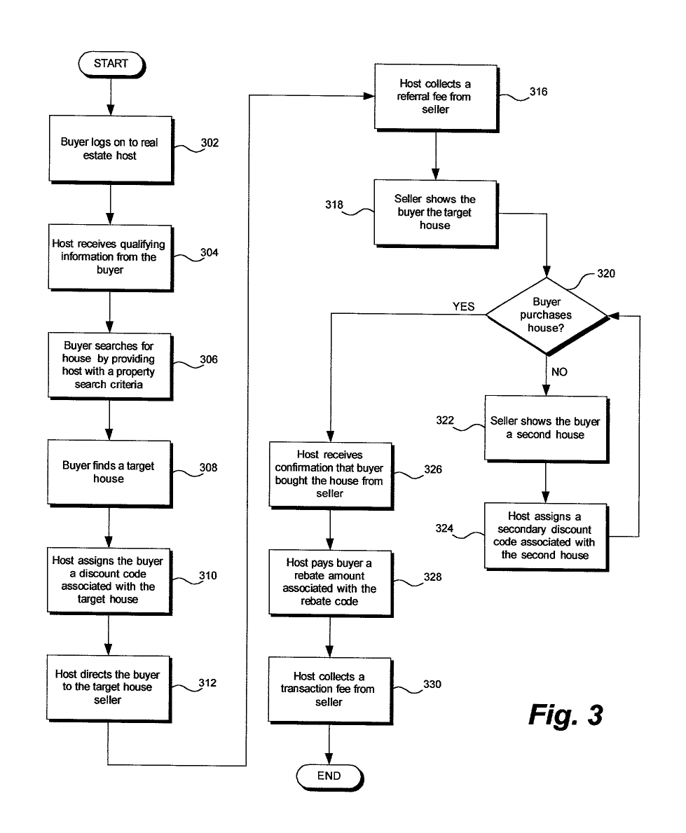

In FIG. 3, a flow chart for an exemplary house purchase transaction process as contemplated by the present invention is shown. The process illustrated in FIG. 3 is very similar to the process of FIG. 2. Thus, for a more rigorous description of process concepts, the reader is referred to the preceding discussion of FIG. 2.

The process begins at accessing step 302, wherein the real estate buyer connects with the real estate host. Once connected, at receiving step 304, the host prompts the buyer for qualifying information. The qualifying information may include the buyer's income and other financial data to help determine if the buyer can afford a given house.

Next, at searching step 306, the buyer enters a property search criteria that specifies the location of and/or the type of house wanted. In response, the host provides the buyer with descriptions of houses matching the buyer's search criteria and qualifying information. This allows the buyer to quickly search and prescreen houses without having to see the houses in person, thereby saving the buyer time and effort in locating a desirable house for sale.

Next, at finding step 308, the buyer chooses at least one target house which he or she would like to view in person. Once a target house is selected by the buyer, the host, at assigning step 310, assigns a unique discount code associated with the house which can be used later to redeem a rebate amount.

At directing step 312, the host sends the buyer's name, contact information and qualifying information to the seller. At this point, the host may charge the seller a referral fee, as noted in collecting step 316. If, after inspecting the buyer's qualifying information, the seller decides to show the house to the buyer, process flow passes to showing step 318, wherein the seller shows the house to the buyer.

Once the buyer examines the target house, he or she decides whether or not to enter into an agreement with the seller and procure the house in decision step 320. If the buyer decides not to purchase the target house, then, at showing step 322, the seller may provide the buyer with a second house to consider purchasing. Furthermore, at assigning step 324, the buyer contacts the host and receives a secondary discount code associated with the second house.

Once the buyer decides to purchase a house (either the target house or another house shown) at decision step 320, process flow passes to receiving step 326, wherein the host receives confirmation that the house was procured by the buyer. This step requires the buyer and seller to provide the host with the discount code associated with the purchased house. After receiving confirmation of the completed transaction, at paying step 328, the host forwards a rebate amount to the buyer. Typically, the rebate amount is in the form of a check made to the order of the buyer. The process is completed at collecting step 330, wherein the host collects a transaction fee from the seller.

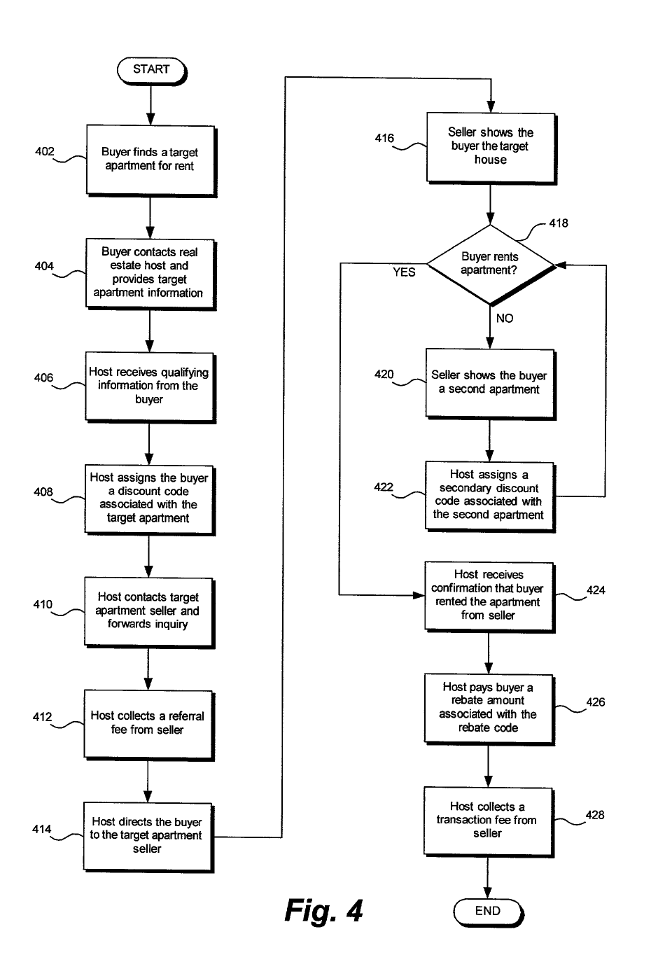

FIG. 4 shows another embodiment of the present invention where the buyer finds a target property from some source other than the real estate host. Thus, at finding step 402, the buyer finds a target apartment he or she is interested in renting without searching the host's property database. For instance, the buyer may find the target property through a newspaper advertisement, an open house, a friend, or any other possible source. Regardless of how the target apartment is found, the process continues to accessing step 404.

At accessing step 404, the buyer logs on to the real estate host and provides information about the target apartment he or she is interested in renting. The information may include the apartment address, the rent amount, and the seller's address and phone number. In addition, at receiving step 406, the host receives qualifying information about the buyer, such as the buyer's income and other financial information. After obtaining the qualifying information from the buyer, control passes to assigning step 408.

At assigning step 408, the buyer is given a discount code associated with the target apartment. The discount code, as previously discussed, permits the buyer to redeem a rebate amount from the host if the buyer ultimately rents the target apartment. In this specific embodiment, however, whether a rebate amount will be paid to the buyer is conditioned upon the target property seller's willingness to pay the host a transaction fee.

Next, at contacting step 410, the host communicates with the seller to determine if the seller is willing to pay the host a transaction fee if the buyer ultimately rents an apartment offered by the seller. If the seller agrees to do so, the host provides the seller with the buyer's qualifying information and contact information. The host may also collect a referral fee from the seller at collecting step 412. After sending the qualifying information to the apartment seller, the seller may choose to show the apartment to the buyer and the process continues to directing step 414.

At directing step 414, the host directs the buyer to the seller so that the seller can show the target apartment to the buyer. Next, at showing step 416, the seller shows the apartment to the buyer. After the buyer examines the target apartment, he or she decides whether or not to enter into a rental agreement with the seller at decision step 418. If the buyer decides not to rent the target apartment, then, at showing step 420, the seller may provide the buyer with a second apartment to consider renting. Furthermore, at assigning step 422, the buyer contacts the host and receives a secondary discount code associated with the second apartment.

Once the buyer decides to rent an apartment from the seller, process flow passes to receiving step 424, wherein the host receives confirmation that the apartment was procured by the buyer. This step requires the buyer and seller to provide the host with the discount code associated with the rented apartment. After receiving confirmation of the completed transaction, at paying step 426, the host forwards a rebate amount to the buyer. The process is concluded at collecting step 428, wherein the host collects the transaction fee from the seller.

The foregoing description of the invention has been presented for purposes of illustration and description. It is not intended to be exhaustive or to limit the invention to the precise form disclosed, and other modifications and variations may be possible in light of the above teachings. The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for conducting a real estate transaction between a real estate buyer and a real estate seller, the method comprising:
receiving a property search criteria from the real estate buyer;
assigning a discount code to the real estate buyer, said discount code being associated with a target property; and
if the real estate buyer procures said target property:
paying the real estate buyer a rebate amount; and
collecting a transaction fee from the real estate seller, said transaction fee including said rebate amount.

2. The method of claim 1, wherein the real estate buyer rents said target property.

3. The method of claim 1, wherein the real estate buyer purchases title of said target property.

4. The method of claim 1, further comprising:
receiving qualifying information from the real estate buyer; and
providing said qualifying information to the real estate seller of said target property.

5. The method of claim 4, further comprising searching a database for said target property using said qualifying information.

6. The method of claim 1, further comprising searching a database for said target property using said property search criteria.

7. The method of claim 1, further comprising receiving confirmation that the real estate buyer procured said target property.

8. The method of claim 1, further comprising directing the real estate buyer to the real estate seller.

9. The method of claim 8, further comprising collecting a referral fee from the real estate seller after directing the real estate buyer to the real estate seller.

10. The method of claim 1, wherein if the real estate buyer does not procure said target property, assigning the real estate buyer a secondary discount code, the secondary discount code being associated with a second property shown by the real estate seller.

11. The method of claim 10, wherein if the real estate buyer procures said second property:
paying the real estate buyer said rebate amount; and
collecting said rebate amount and said transaction fee from the real estate seller.

12. The method of claim 1, wherein paying the real estate buyer a rebate amount further comprises receiving confirmation that the real estate buyer procured said target property.

13. A computer-readable medium having computer-executable instructions for performing the operations recited in claim 1.

14. A system for conducting a real estate transaction, the system comprising:
a real estate seller offering a target property for one of purchase and rent;
a real estate buyer procuring said target property from said real estate seller; and
a real estate host listing said target property in a host database, said real estate host assigns a discount code to said real estate buyer, said discount code being associated to said target property such that when said real estate buyer procures said target property said host pays said real estate buyer a rebate amount.

15. The method of claim 14, wherein said real estate host receives qualifying information from said real estate buyer.

16. The method of claim 14, wherein said real estate host receives a property search criteria from said real estate buyer.

17. The method of claim 14, wherein said real estate buyer searches for said target property on said host database.

18. The method of claim 14, wherein said real estate host receives confirmation from said real estate buyer that said real estate buyer procured target property.

19. The method of claim 14, wherein said real estate host collects a referral fee from said real estate seller after directing said real estate buyer to said real estate seller.

20. The method of claim 14, wherein said real estate host collects a transaction fee from said real estate seller after said real estate buyer procures said target property.
